(19) United States
(12) Patent Application Publication
(10) Pub. No.: US 2008/0156585 A1
(43) Pub. Date: Jul. 3, 2008

(54) Ladder safety mat

(76) Inventors: Shawn Pyktel, Woodbridge, VA (US); Michelle Pyktel, Woodbridge, VA (US)

Correspondence Address: PATTON BOGGS LLP, 2550 M STREET NW, WASHINGTON, DC, 20037-1350, US

(21) Appl. No.: 11/646,363

(22) Filed: Dec. 28, 2006

(51) Int. Cl. E06C 7/42

(52) U.S. Cl. 182/108

(57) ABSTRACT

A ladder safety mat for securing the base of a ladder to a supporting surface including a flexible body having a first surface and a second surface, the second surface providing a frictional resistance to the supporting surface; and two open vertical sockets located on the first surface and spaced apart from each other for accepting in each the lower end of a stile from the ladder, wherein the body and the vertical sockets are one molded piece. In another embodiment, the ladder safety mat includes a retaining ridge extending upward from the top surface of the ladder safety mat for retaining the lower ends of the stiles of the ladder. In yet another embodiment, the ladder safety mat includes recessed sockets for retaining the lower ends of the stiles of the ladder.

### FIELD OF THE INVENTION

The present invention relates to safety mats. More particularly, the present invention relates to safety mats for ladders.

### PROBLEM

The use of apparatuses to stabilize ladders in use is known in the prior art. Typically, they include broad bases and many mechanical parts that secure and stabilize the base of a ladder. Since ladders are used indoors and outdoors, they must be stable on smooth hard indoor surfaces and soft outdoor surfaces. Many attempts have been made to solve the problems associated with such use. In one attempt, a ladder prop is used that includes a rigid metal body and a screw or auger for securing the prop to the ground. The rigid metal body does not include any surfaces that would provide sufficient frictional resistance for indoor use on hard surfaces. In addition, time must be spent by a user to tighten and loosen locking screws used to hold the lower ends of the ladder stiles in place in the metal body.

In another attempt, a ladder stabilizer includes a hard metal base that is adapted for receiving loops of strips of soft resilient non-slip material, such as recycled tires. With this stabilizer, the base is also made of a hard material, thus it wouldn't provide flexibility on uneven ground. It further requires replacement of the loops of the non-slip recycled rubber parts when they become worm. This stabilizer does not provide any features for retaining the ends of a ladder, instead, the ends of the ladder rest on the flat horizontal surface covered in recycled rubber.

In yet another attempt, a ladder stabilizer includes a rigid metal base having a vertical abutment surface that is used to stabilize a ladder. In this attempt, the metal plate includes holes at its corners for accepting pins to secure the rigid metal base to a soft surface. Tether lines may be employed to further secure the ladder to the metal base plate. Flexible adhesion sheets are also provided for mounting to the bottom surface of the metal base to provide frictional resistance between the underside of the rigid metal base and the supporting surface, such as on concrete, when the mounting pins can not be used. Again, this ladder stabilizer requires the time to connect and disconnect the tether lines from the ladder when using the stabilizer.

In still yet another attempt, a ladder stabilizer includes an elongated rigid pad that comprises a left and right section that telescope outwardly relative to each other to form an elongated rectangular pad for stabilizing a stepladder. An integrally formed socket extends upwardly from each of the sections for accepting the lower ends of the stiles of the stepladder. The purpose of the elongated rectangular pad is to provide shoring for the stepladder ends in soft material to prevent them from sinking into the material, and thus causing the ladder to become unstable. Nothing is disclosed regarding a frictional resistance surface located on the bottom of the rigid pad for use on solid surfaces. In addition, this stabilizer includes many mechanical parts for its operation.

In another attempt, a ladder stabilizer includes a pair of slider members individually connect with the lower ends of a ladder to provide adjustable height support for each individual lower end so as improve the stability and levelness of the ladder when it is on uneven terrain. Each of the pair of slider members further includes holes for accepting a set of pins for securing each slider member into soft surfaces. Similarly as described above, this stabilizer includes a plurality of mechanical parts for its operation.

In a different attempt, a ladder stabilizer includes a triangular framed platform including a trough for accepting a ladder. The triangular framed platform has an adjustable vertical leg at each of its three corners for adjusting the level of the trough on uneven terrain. Each vertical leg terminates in an exchangeable end for use in either a soft surface or a hard surface. In addition to the platform, the stabilizer includes a plurality of mechanical parts used for leveling the platform.

In another attempt, a rigid generally flat base includes a linear channel extending along the upper surface of the base and a lower surface that includes an enhanced frictional material, such as rubber or the like. The base consists of two aligned parts that extend distally laterally from each other to provide a wider base for stability. Additionally, the apparatus includes levelers for each ladder stile for adjusting the height of each stile when used in uneven terrain. Vulcanized molded rubber and profiled bottoms are part of the bottom surface of each extendable base member, likewise, this stabilizer includes a plurality of parts for its operation.

Information relevant to attempts to address these problems can be found in the U.S. Pat. No. 776,446 issued 29 Nov. 1904 to Williamson; U.S. Pat. No. 2,139,025 issued 6 Dec. 1938 to Lutey; U.S. Pat. No. 3,618,703 issued 9 Nov. 1971 to Wilke; U.S. Pat. No. 5,078,231 issued 07 Jan. 1992 to Davis; U.S. Pat. No. 5,417,302 issued 23 May 1995 to McElfresh, U.S. Pat. No. 5,669,462 issued 23 Sep. 1997 to Jennings; U.S. Pat. No. 6,044,929 issued 1 Apr. 2000 to Wishner; U.S. Pat. No. 6,655,497 issued 02 Dec. 2003 to Weatherall, and D441,462 issued 01 May 2001 to Peters.

### SOLUTION

The above-described problems are solved and a technical advance achieved by the present ladder safety mat. The present ladder safety mat is easy to use and does not have a plurality of mechanical parts for its operation. It is further designed to provide frictional resistance on both hard and soft surfaces, and thus can be used indoors or outdoors. Further, due to its flexibility, it is less unstable on uneven surfaces than known rigid stabilizers.

The present ladder safety mat includes two sockets spaced apart on the upper side of the ladder safety mat for receiving the lower ends of a ladder. This provides easy use with the ladder and does not require additional coupling or uncoupling of known ladder restraining devices to secure the ladder ends to the ladder safety mat. The sockets provide restraining boundaries encircling each lower end of the ladder to provide for a secure operating environment.

Additionally, the ladder safety mat is flexible so as to provide additional stability on uneven surfaces over known rigid stabilizers. Further, the present ladder safety mat is molded in one piece for simplicity of manufacturing and use. Thus, no additional mechanical parts are required to be incorporated into the ladder safety mat for its operation.

### SUMMARY

A ladder safety mat for securing the base of a ladder to a supporting surface including a flexible body having a first surface and a second surface, the second surface providing a frictional resistance to the supporting surface; and two open vertical sockets located on the first surface and spaced apart from each other for accepting in each the lower end of a stile from the ladder, wherein the body and the vertical sockets are one molded piece. In another embodiment, the ladder safety mat includes a retaining ridge extending upward from the top surface of the ladder safety mat for retaining the lower ends of the stiles of the ladder. In yet another embodiment, the ladder safety mat includes recessed sockets for retaining the lower ends of the stiles of the ladder.

### BRIEF DESCRIPTION OF THE DRAWINGS

FIG. 1 illustrates a side view of a ladder safety mat in use with a ladder according to an embodiment of the present invention;

FIG. 2 illustrates a perspective view of a ladder safety mat of FIG. 1 according to an embodiment of the present invention;

FIG. 3 illustrates a plan view of the ladder safety mat of FIG. 2 according to an embodiment of the present invention;

FIG. 4 illustrates a side view of the ladder safety mat of FIG. 2 according to an embodiment of the present invention;

FIG. 5 illustrates a plan view of a ladder safety mat showing grommets located at each corner of the ladder safety mat according to another embodiment of the present invention;

FIG. 6 illustrates a plan view of a ladder safety mat showing grommets located more proximal to the center of the ladder safety mat according to another embodiment of the present invention;

FIG. 7 illustrates a plan view of the ladder safety mat showing securing pins of the ladder safety mat of FIG. 4 according to an embodiment of the present invention;

FIG. 8 illustrates a back view of the ladder safety mat showing grommets located at each corner of the ladder safety mat of FIG. 5 according to an embodiment of the present invention;

FIG. 9 illustrates a perspective view of a ladder safety mat according to another embodiment of the present invention;

FIG. 10 illustrates a side view of a ladder safety mat of FIG. 9 according to another embodiment of the present invention;

FIG. 11 illustrates a plan view of a ladder safety mat of FIG. 9 according to another embodiment of the present invention;

FIG. 12 illustrates a plan view of a ladder safety mat of FIG. 9 showing grommets located more proximal to the center of the ladder safety mat according to another embodiment of the present invention;

FIG. 13 illustrates a cut-away view of a ladder safety mat through the lines 13-13 of FIG. 14 according to another embodiment of the present invention;

FIG. 14 illustrates a plan view of the ladder safety mat of FIG. 13 according to an embodiment of the present invention;

FIG. 15 illustrates a perspective view of a ladder safety mat according to another embodiment of the present invention;

FIG. 16 illustrates a cut-away view of a ladder safety mat through the lines 16-16 of FIG. 15 in use with a ladder according to an embodiment of the present invention;

FIG. 17 illustrates a cut-away view of a ladder safety mat through the lines 16-16 of FIG. 15 according to another embodiment of the present invention;

FIG. 18 illustrates a plan view of the ladder safety mat of FIG. 15 according to an embodiment of the present invention;

FIG. 19 illustrates a perspective of a ladder safety mat according to another embodiment of the present invention;

FIG. 20 illustrates a side view of a securing device according to another embodiment of the present invention; and

FIG. 21 illustrates a flow diagram of a process for making a ladder safety mat according to an embodiment of the present invention.

### DETAILED DESCRIPTION OF THE DRAWINGS

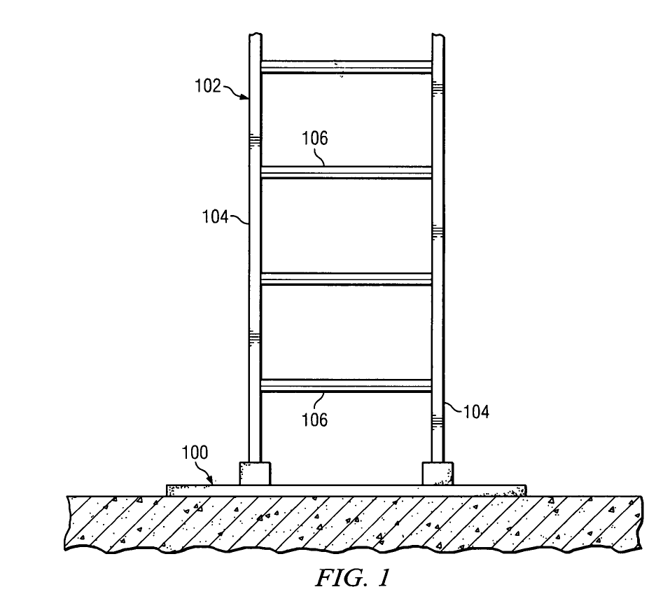

Like reference numerals are used to indicate like parts throughout the drawings. FIG. 1 illustrates a ladder safety mat 100 that is in use with a ladder 102. Typically, ladder 102 includes a pair of stiles 104 and a plurality of rungs 106. It is shown in FIG. 1 that the lower ends of the stiles 104 are inserted into the ladder safety mat 100. The ladder safety mat 100 can be used with most types of ladders, including step ladders, extension ladders, fixed ladders, telescopic ladders, and the like.

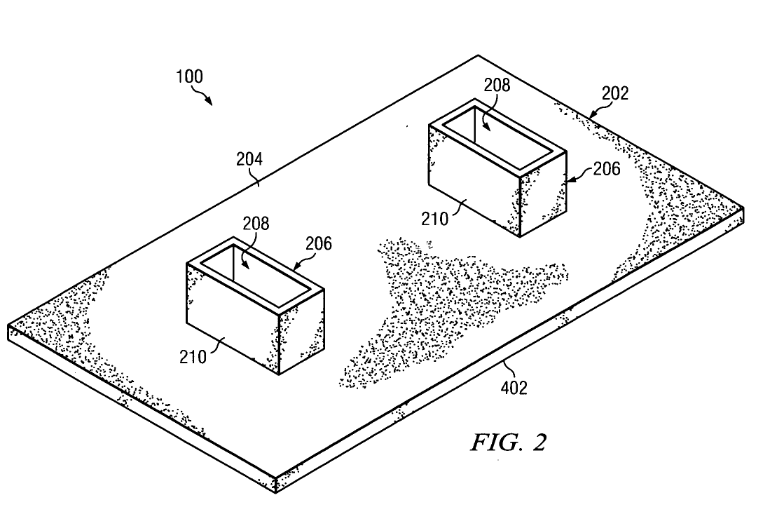

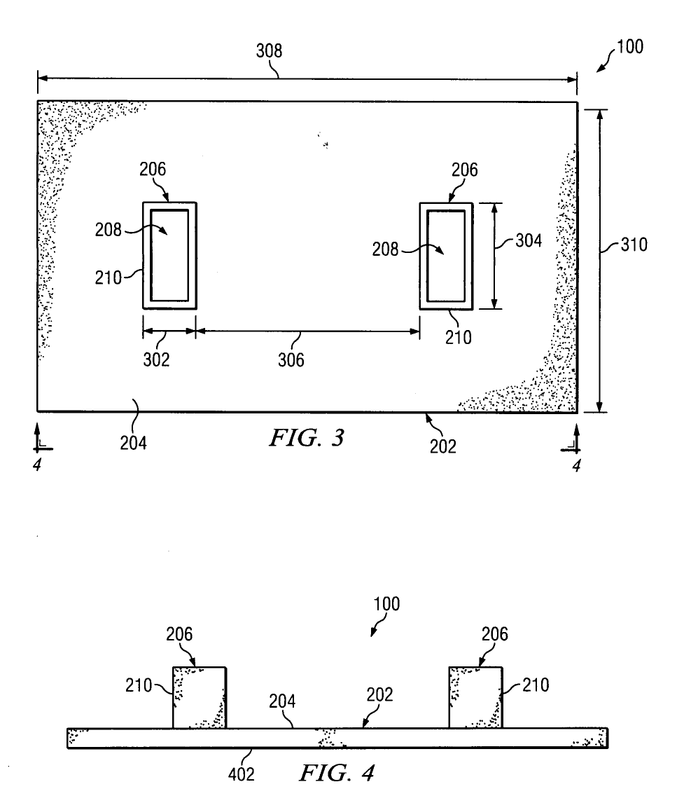

Turning to FIGS. 2-4, ladder safety mat 100 includes a body 202 having a top surface 204 and a bottom surface 402. Located on the top surface 204 is preferably a pair of vertical sockets 206 for receiving the lower ends of the stiles 104. Each of the sockets 206 includes a vertical cavity 208 that is defined by a series of walls 210. The cavities 208 of the sockets 206 extend downward until they terminate in the body 202. The thickness of the body 202 is preferably dependent upon the application of the ladder safety mat 200 and the composition of its material. In one aspect, the thickness of the body 202 is approximately from about ¼ inch to about 2 inches, and more preferably about 1 inch. Preferably, the sockets 206 may be spaced apart at any distance to accommodate a particular width of stiles 104 of a ladder 102 to be used. In one aspect, the distal inwardly facing walls 210 of the sockets 206, shown as distance 306, are spaced approximately from about 10 to about 18 inches apart from each other. More preferably, the distance 306 of the distal inwardly facing walls 210 of the sockets 206 are spaced approximately 14 inches apart from each other.

Additionally, the distance between the walls 210 of each socket 206 may be dependent upon a particular ladder 102 being used in an application. For instance, if the lower ends of the stiles 104 have a small footprint, then a correspondingly smaller distance, shown as distances 302 and 304, between the walls 210 of the sockets 206 will be necessary. Conversely, it the lower ends of the stiles 104 have a large footprint, such as with hingeable or rotatable ends, then a greater distance, shown as distances 302 and 304, between the walls 210 of the sockets 206 will be necessary. In one aspect, the distance 302 of the width of walls 210 of the sockets 206 is approximately from about 2 inches to about 6 inches. More preferably, the distance 302 of the width of walls 210 is 4 inches. In another aspect, the distance 304 of the walls 210 of the sockets 206 is approximately from about 4 inches to about 12 inches. More preferably, the distance 304 of the 210 is 8 inches. The thickness of the walls 210 is preferably dependent upon the application of the ladder safety mat 100 and the composition of its material. In one aspect, the thickness of the walls 210 is approximately from about ¼ inch to about 2 inches, and more preferably about 1 inch.

In addition to the above dimensions, the height of the sockets 206 may be dependent upon the application and the type of ladder 102 used and the rigidity of the composition of the material it is made from. In one aspect, the height of the sockets 206 are preferably approximately from about 1 inch to about 4 inches, and more preferably the height of the sockets 206 is 1½ inches.

Preferably, the dimensions of the body 202 are dependent upon the desired application and ladder 102 used. In one aspect, the width of the body 202, shown as distance 308, is approximately from about 50 inches to 24 inches, and more preferably the width of the body 202 is 34 inches. In another aspect, the length of the body 202, shown as distance 310, is approximately from about 24 inches to about 12 inches, and more preferably the length of the body 202 is 18 inches.

Additionally, the thickness of the body 202 is dependent upon the desired flexibility of it for a particular application. In addition, the thickness of the body 202 may be dependent upon the composition of the material as well. In one aspect, the thickness of the body 202 is from about ½ inch to about 2 inches, and more preferably the thickness of the body 202 is 1 inch.

Moreover, the geometric shape of the body 202 may be any shape, including symmetrical and asymmetrical shapes, and the like. The shape of the sockets 206 may also be other shapes, such as oval, circular, square, etc.

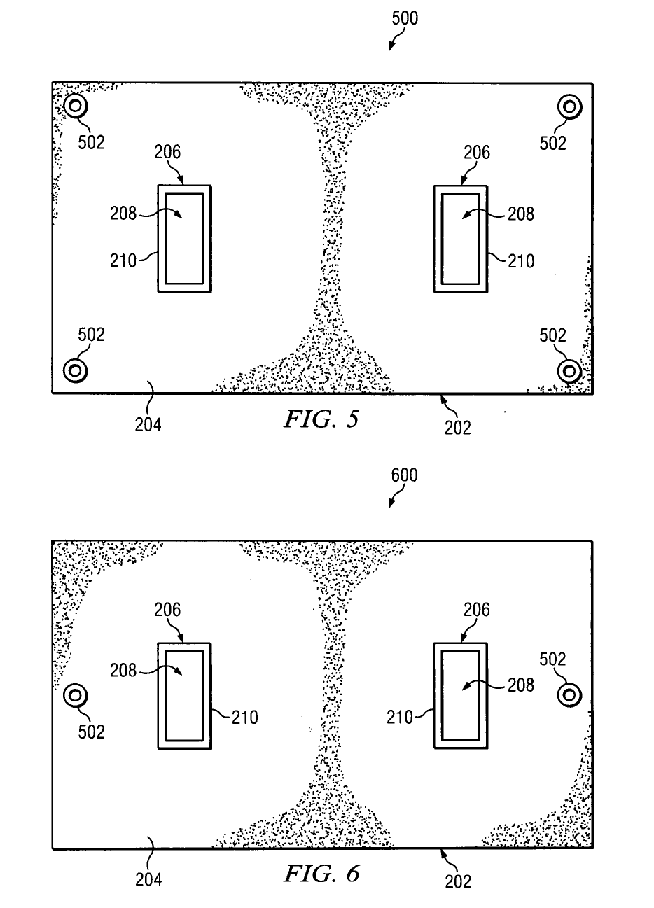

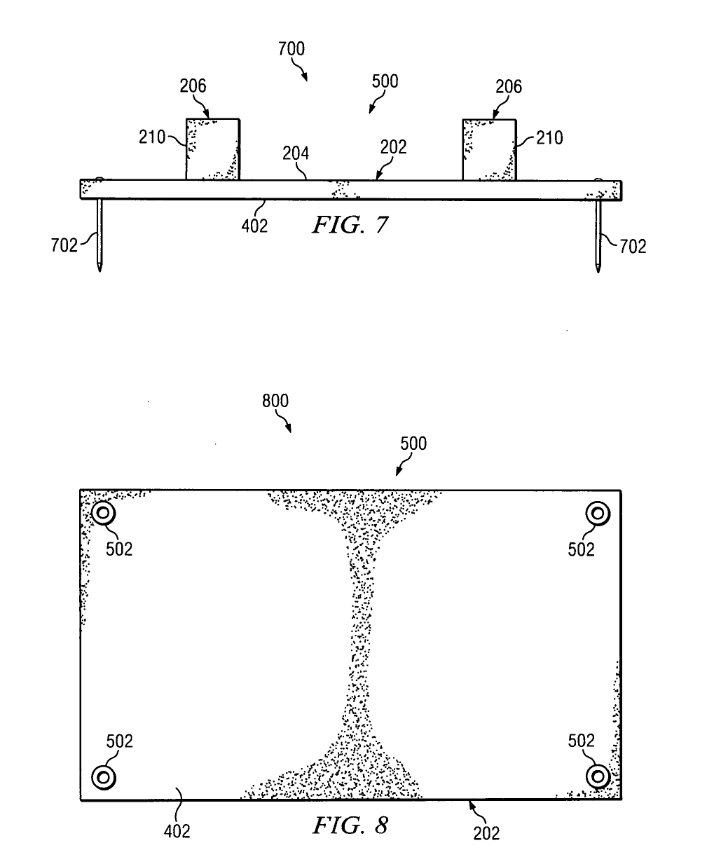

Referring to FIGS. 5-6, another embodiment 500 of the present ladder safety mat shows a grommet 502 located near each corner of the ladder safety mat 500. These grommets 502 are disposed through the entire thickness of the ladder safety mat 500 and are for receiving a securing device 702 (FIG. 7), such as a spike, screw, nail, or the like. The securing devices 702 protrude through the grommets 502 to secure the ladder safety mat 500 to a soft surface. In addition, embodiment 600 of the ladder safety mat has grommets 502 located nearer or proximal to the central part of the ladder safety mat 600 for receiving the securing devices 702. Referring to FIG. 7, another embodiment 700 of the present ladder safety mat shows the securing device 702 protruding through the ladder safety mat 500. The grommets 502 may be comprised of a metal ring with a protective outer shell or coating to prevent scratching on finished or hard surfaces.

FIG. 8 is an illustration 800 of the bottom surface 402 of the ladder safety mat 500 showing the grommets 502 disposing through the bottom surface 402. In addition to the composition of the ladder safety mats 100, 500, and 600, the present invention may further include a texturing, relief, or surface treatment as part of the bottom surface 402 for increased frictional force.

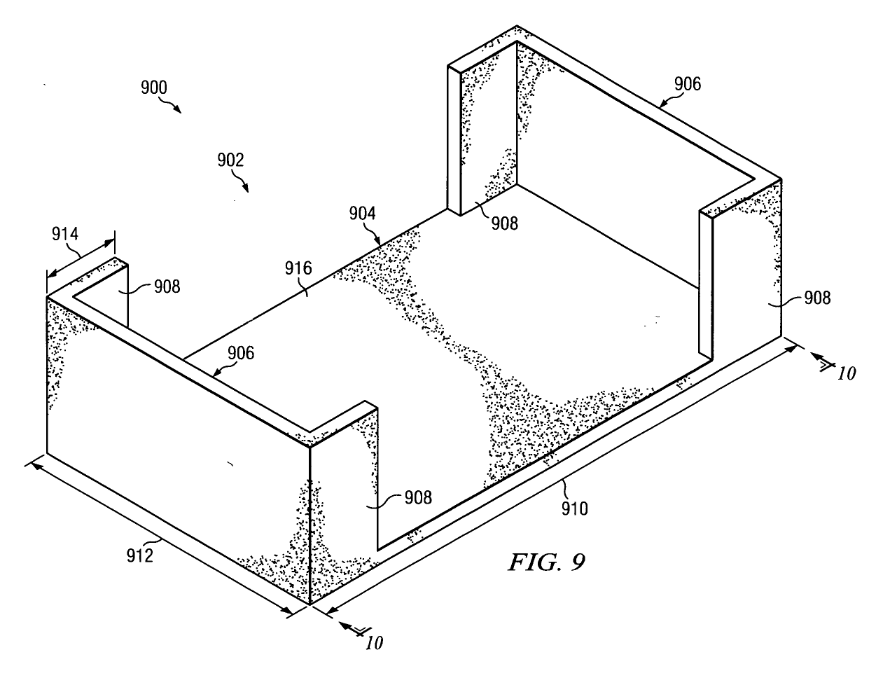

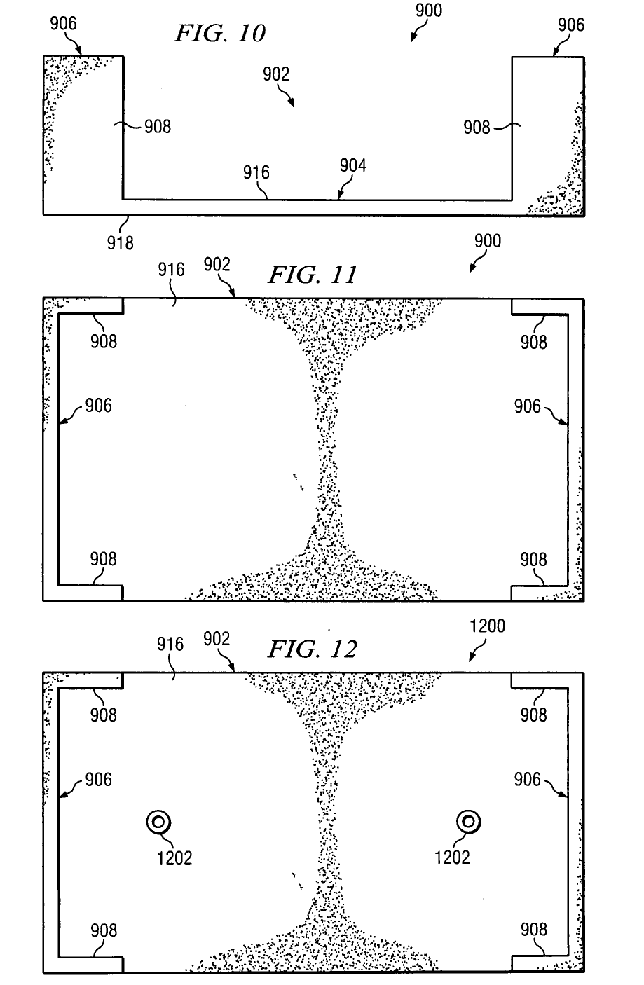

FIGS. 9-11 illustrate another embodiment 900 of a ladder safety mat that has two opposing U-shaped ends 906 that face inwardly toward one another for securing the lower ends of the stiles 104 of the ladder 102. The ladder safety mat 900 can be used with most types of ladders, including step ladders, extension ladders, fixed ladders, telescopic ladders, and the like. In this embodiment, a lower end of one stile 104 is secured in one U-shaped retaining end 906 and the lower end of the other stile 104 is secured in the other U-shaped retaining end 906. Preferably, the ladder safety mat 900 includes a cut-out portion 902 located between the two ends 906 for allowing unimpeded access to the ladder 102 when it is being, secured by the ladder safety mat 900. The two U-shaped retaining ends 906 extend upward from a substantially planar body 904 as shown in FIG. 9. The body 904 of the ladder safety mat 900 has a top surface 916 and a bottom surface 918.

Preferably, each of the two retaining ends 906 includes two complementary walls 908 that are spaced apart from each other that together define the U-shaped area for each retaining end 906 for retaining each of the lower ends of the stiles 104. These walls 908 are preferably oriented approximately 90° to their respective retaining ends 906. Preferably, the retaining ends 906 are spaced apart at any distance to accommodate a particular width of stiles 104 of a ladder 102 to be used. In one aspect, the distance between the retaining ends 906, as shown as distance 910, is approximately from about 10 inches to 24 inches. More preferably, the distance 910 of the retaining ends 906 is 18 inches. Preferably, the walls 908 extend from about 2 inches to about 6 inches, as shown as distance 914, from the distal edge of their respective retaining end 906. More preferably, the walls 908 extend about 4 inches from the distal edge of their respective retaining end 906. The height of the retaining ends 906 is preferably from about 1 inch to about 4 inches, and more preferably the height of the retaining ends is 1½ inches.

In addition, the length of the retaining end 906, shown as distance 912, and thus the distance between two complementary walls 908, is preferably from about 4 inches to about 12 inches. More preferably, the distance 912 is 8 inches. The thickness of the body 904 is preferably dependent upon the application of the ladder safety mat 900 and the composition of its material. In one aspect, the thickness of the body 904 is approximately from about ¼ inch to about 2 inches, and more preferably about 1 inch.

The thickness of the retaining ends 906 and walls 908 is preferably dependent upon the application of the ladder safety mat 900 and the composition of its material. In one aspect, the thickness of the retaining ends 906 and the walls 908 is approximately from about ¼ inch to about 2 inches, and more preferably about 1 inch. FIG. 12 illustrates another embodiment 1200 of a ladder safety mat that includes grommets 1202 located nearer or proximal to the central part of the ladder safety mat 1200. The locations of the grommets 1202 may be in other locations on the body 904.

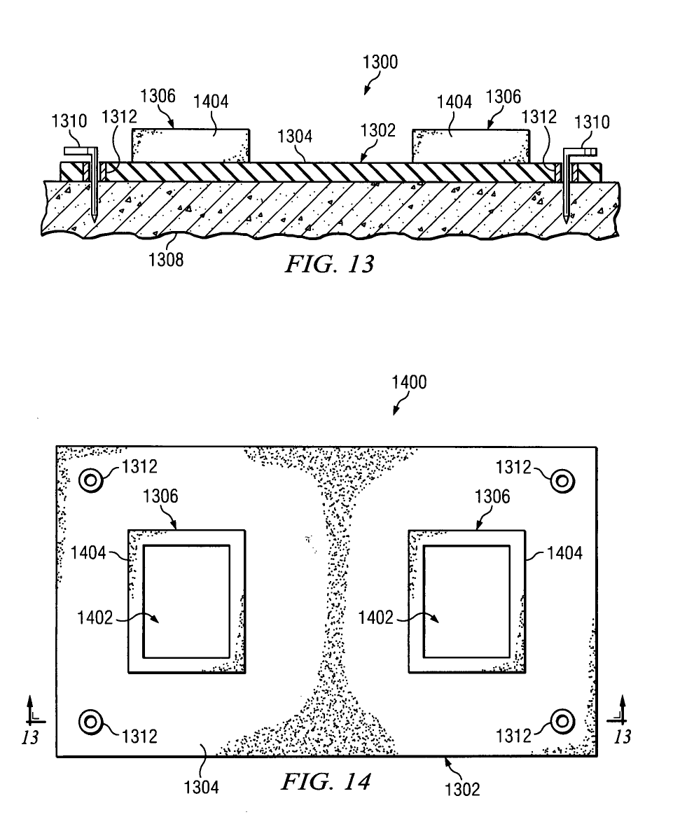

FIGS. 13-14 illustrate another embodiment, shown as 1300, of a ladder safety mat that includes a body 1302 having a top surface 1304 and a bottom surface that is in contact with a supporting surface, such the ground 1308. Located on the top surface 1304 is preferably a pair of vertical sockets 1306 for receiving the lower ends of the stiles 104. Each of the sockets 1306 includes a vertical cavity 1402 that is defined by a series of walls 1404. The cavities 1402 of the sockets 1306 extend downward until they terminate in the body 1302. The thickness of the body 1302 is preferably dependent upon the application of the ladder safety mat 1300 and the composition of its material. In one aspect, the thickness of the body 1302 is approximately from about ¼ inch to about 2 inches, and more preferably about 1 inch. Preferably, the sockets 1306 may be spaced apart at any distance to accommodate a particular width of stiles 104 of a ladder 102 to be used. In one aspect, the distal inwardly facing walls 1404 of the sockets 1306 are spaced approximately from about 10 to about 18 inches apart from each other. More preferably, the distance of the distal inwardly facing walls 1404 of the sockets 1306 are spaced approximately 14 inches apart from each other.

In addition to the above dimensions, the height of the sockets 1306 may be dependent upon the application and the type of ladder 102 used and the rigidity of the composition of the material it is made from. In this embodiment, the height of the sockets 1306 are preferably less than the height of the sockets 206.

Additionally, the thickness of the body 1302 is dependent upon the desired flexibility of it for a particular application. In addition, the thickness of the body 1302 may be dependent upon the composition of the material as well. In one aspect, the thickness of the body 1302 is from about ½ inch to about 2 inches, and more preferably the thickness of the body 1302 is 1 inch.

The ladder safety mat 1300 also preferably includes grommets 1312, such as those described above. The grommets 1312 are for accepting securing devices 1310 that secure the ladder safety mat 1300 to the ground 1308.

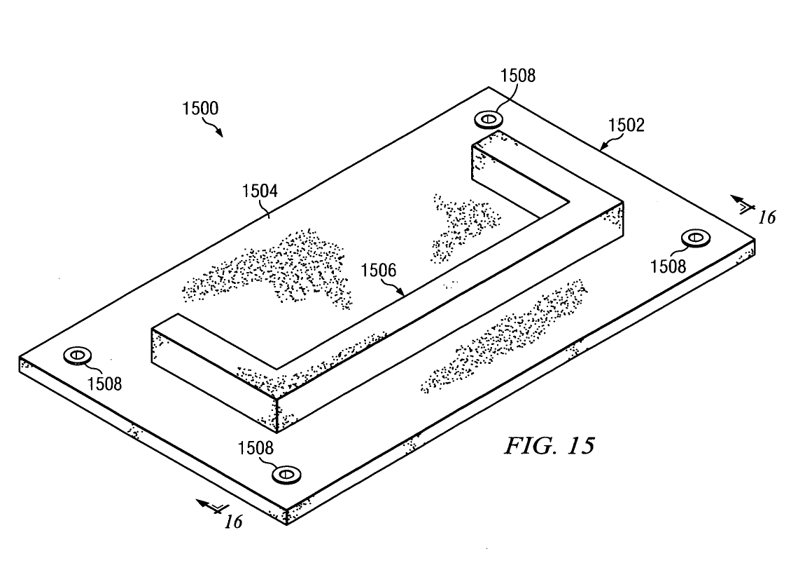

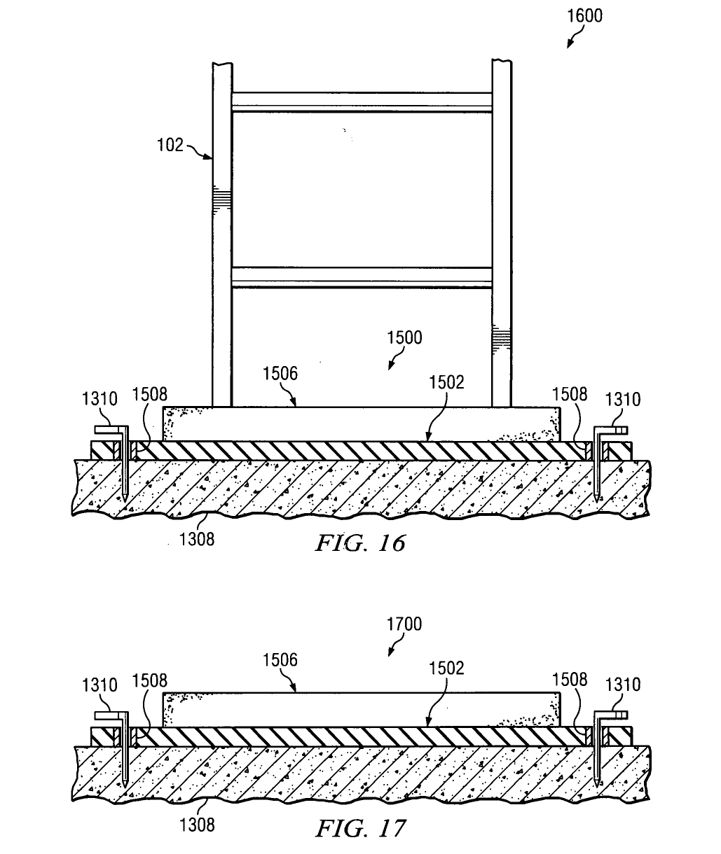

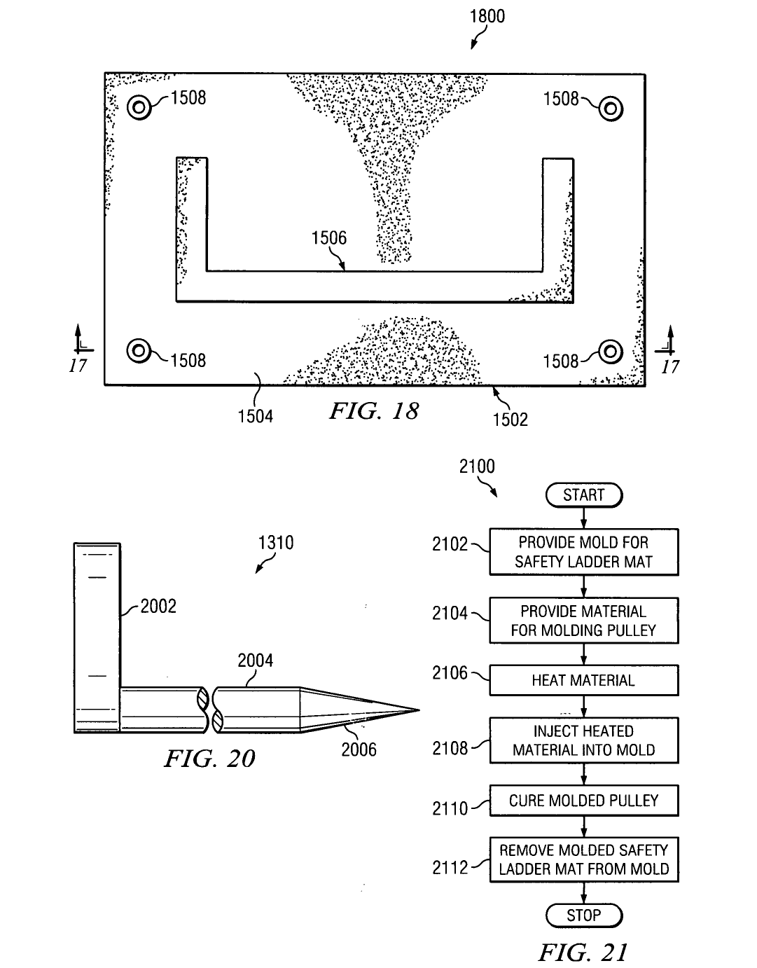

FIGS. 15-18 illustrate another embodiment, shown as 1500, 1600, 1700, and 1800, collectively, of a ladder safety mat that includes a body 1502 having a top surface 1504 and a bottom surface that is in contact with a supporting surface, such the ground 1308. Located on the top surface 1504 is preferably a retaining ridge 1506 for retaining the lower ends of the stiles 104. The retaining ridge 1506 extends upward from the top surface 1504 to provide a stop for the stiles 104 to rest against to prevent the ladder 102 from slipping when in use. The thickness of the body 1502 is preferably of the dimensions and compositions of that disclosed herein. In this embodiment, the retaining ridge 1506 is unshaped to provide retention to the stiles 104 in several different directions.

In addition to the above dimensions, the height of the retaining ridge 1506 may be dependent upon the application and the type of ladder 102 used and the rigidity of the composition of the material it is made from. In this embodiment, the height of the retaining ridge 1506 is preferably between is preferably from about 1 inch to about 4 inches, and more preferably the height of the retaining ridge 1506 is 1½ inches in height.

The ladder safety mat 1500 also preferably includes grommets 1512, such as those described above. The grommets 1512 are for accepting securing devices 1310 that secure the ladder safety mat 1500 to the ground 1308.

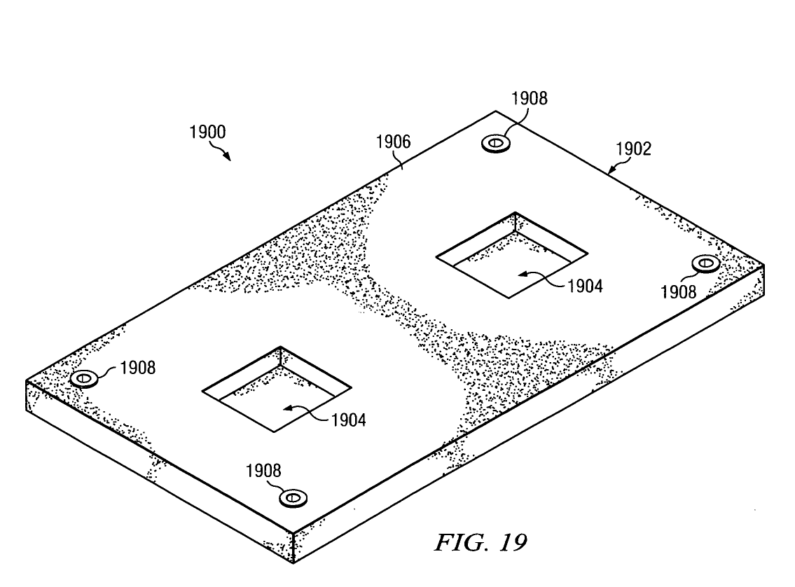

FIG. 19 illustrates another embodiment 1900 of a ladder safety mat that includes a body 1902 having a top surface 1906 and a bottom surface that is in contact with a supporting surface, such the ground 1308 (not shown). Located within the body 1902 is preferably a pair of recessed sockets 1904 for receiving the lower ends of the stiles 104. Each of the recessed sockets 1904 includes a vertical cavity that is created by the recessed sockets 1904 and the body 1902. The recessed sockets 1904 extend into the body 1902. The thickness of the body 1902 is preferably dependent upon the application of the ladder safety mat 1900 and the composition of its material. In one aspect, the thickness of the body 1902 is approximately from about ¼ inch to about 2 inches, and more preferably about 1 inch. Preferably, the recessed sockets 1904 may be spaced apart at any distance to accommodate a particular width of stiles 104 of a ladder 102 to be used. In one aspect, the distal inwardly facing walls of the recessed sockets 1904 are spaced approximately from about 10 to about 18 inches apart from each other. More preferably, the distance of the distal inwardly facing walls of the recessed sockets 1904 are spaced approximately 14 inches apart from each other.

As discussed above, the ladder safety mat 1900 also preferably includes grommets 1908. The grommets 1908 are for accepting securing devices 1310 that secure the ladder safety mat 1900 to the ground 1308 (not shown).

Moreover, the geometric shape of the bodies 1302, 1502, and 1902 may be any shape, including symmetrical and asymmetrical shapes, and the like. The shape of the sockets 1306, channels 1904, and retaining ridge 1506 may also be other shapes, such as oval, circular, square, etc.

The ladder safety mats 100, 500, 600, 900, 1200, 1300, and 1900 are preferably molded in one piece to provide superior strength and flexibility while being simpler to manufacture. The ladder safety mats 100, 500, 600, 900, 1200, 1300, and 1900 are composed of a material that is preferably capable to being heated and injected into a mold for producing the ladder safety mats 100, 500, 600, 900, 1200, 1300, and 1900. The material is preferably resilient enough to provide the rigidity necessary for securing the ladders 102 into the safety mats 100, 500, 600, 900, 1200, 1300, and 1900 while providing a sufficient frictional coefficient or “stickiness” to hold the ladder 102 in place on a variety of surfaces that may be found either indoors, outdoors, or both. Some exemplary materials include moldable non-slip rubber, thermoplastics, fiber reinforced polymers, fiber reinforced plastics, glass strand mat, isophthalic resin, Dycem®, polypropylene, compositions of the these materials, and the like.

FIG. 20 illustrates an embodiment 1310 of a securing device for securing ladder safety mats 100, 500, 600, 900, 1200, 1300, and 1900 to the ground 1308 or other supporting surface that may accept the securing device 1310. In this embodiment, the securing device 1310 includes a cylindrically shaped body 2004 having two ends. One end is connected to a handle 2002 for exerting force by a user to drive the securing device 1310 into the ground 1308 or for removing the securing device 1310 from the ground 1308. The handle 2002 may have a flat surface for accepting a driving force, such as by a boot or hammer, to drive it into the ground 1308. The other end of the cylindrically shaped body 2004 tapers to a pointed end 2006 for penetrating the ground 1308 with the securing device 1310. The securing device 1310 is made from a material that provides sufficient rigidity when securing the ladder safety mats 100, 500, 600, 900, 1200, 1300, and 1900 to the ground 1308 through their respective grommets.

In addition to the aforementioned aspects and embodiments of the present ladder safety mats 100, 500, 600, 900, 1200, 1300, and 1900 the present invention further includes methods for manufacturing a ladder safety mat 100, 500, 600, 900, 1200, 1300, and 1900.

FIG. 21 illustrates a flow diagram of an embodiment 2100 of one such process. In step 2102, a mold is provided for molding the present ladder safety mats 100, 500, 600, 900, 1200, 1300, and 1900. In one embodiment, molding is done on a standard hydraulic injection molding machine using conventional tooling. In one embodiment, the mold is a three plate tool having a core side and a cavity side. Additionally, in this embodiment, the molding apparatus includes a hot to cold runner system. In one embodiment, the mold produces a finished ladder safety mat in a single stage, also known as a shoot and ship product. In step 2104, a material is provided based on the desired rigidity and flexibility of the ladder safety mat.

In step 2106, the molding apparatus is heated to a temperature consistent with the material selected to be injected. In one embodiment, the material is non-slip rubber. The processing temperatures and parameters are based on material supplier recommendations according to the material used.

In step 2108, the hot runner system within the molding apparatus delivers the heated material into the core and cavity. In step 2110, the heated material is cured for to allow the material to set-up and solidify.

In step 2112, the molding apparatus opens, the tool splits in half, to separate the core cavity half from the cavity half. This step can be done manually or by robotics, then the core halves are laid flat on a table outside of the machine to allow for continued cooling.

Although there has been described what is at present considered to be the preferred embodiments of the present ladder safety mat and methods for making the ladder safety mat, it will be understood that the present ladder safety mat can be embodied in other specific forms without departing from the spirit or essential characteristics thereof. For example, different materials and different shaped sockets and wall configurations could be used, other than those described herein, without departing from the spirit or essential characteristics of the present ladder safety mat. Also, the present ladder safety mat could be manufactured by other means such as stamping, and the like without departing from the spirit or essential characteristics of the present ladder safety mat. The present embodiments are, therefore, to be considered in all aspects as illustrative and not restrictive. The scope of the invention is indicated by the appended claims rather than the foregoing description.

What is claimed:

1. A ladder safety mat for securing the base of a ladder to a supporting surface comprising:
a flexible body having a first surface and a second surface, said second surface providing a frictional resistance to said supporting surface; and
two open vertical sockets located on said first surface and spaced apart from each other for accepting in each the lower end of a stile from said ladder, wherein said body and said vertical sockets are one molded piece.

2. The ladder safety mat of claim 1 further comprising:
at least one grommet disposed through said body for accepting a securing device to secure said ladder safety mat to said supporting surface.

3. The ladder safety mat of claim 1 wherein the outer periphery of said sockets are shaped to accept said lower ends of said stiles into said sockets.

4. The ladder safety mat of claim 1 wherein said second side further includes a relief pattern.

5. The ladder safety mat of claim 1 wherein said ladder safety mat is made from a non-slip moldable material.

6. The ladder safety mat of claim 5 wherein said non-slip moldable material is selected from the group consisting of rubber, rubber compositions, thermoplastics, fiber reinforced polymers, fiber reinforced plastics, glass strand mat, isophthalic resin, Dycem®, polypropylene, and compositions of these materials.

7. A ladder safety mat comprising:
a flexible planar rectangular body having a first surface and a second surface, said body having a first dimension of from about 24 inches to about 50 inches, a second dimension from about 12 inches to about 18 inches, and a thickness from about ½ inch to about 2 inches;
two open rectangular shaped vertical sockets located on said first surface and spaced apart from each other a distance from about 10 inches to about 18 inches and having a vertical height from said first surface from about 1 inch to about 4 inches for accepting in each the lower end of a stile from said ladder, wherein said body and said vertical sockets are one molded piece;
at least one grommet disposed through said body for accepting a securing device to secure said ladder safety mat to a supporting surface, wherein said flexible planar rectangular body is a single molded piece comprised of a non-slip moldable material.

8. The ladder safety mat of claim 7 wherein said second side further includes a relief pattern.

9. The ladder safety mat of claim 7 wherein said non-slip moldable material is selected from the group consisting of rubber, rubber compositions, thermoplastics, fiber reinforced polymers fiber reinforced plastics, glass strand mat, isophthalic resin, Dycem®, polypropylene, and compositions of these materials.

10. A method for manufacturing a molded ladder safety mat comprising:
providing a mold for said ladder safety mat having cavities for producing an a body having a first surface, a second surface, and two open vertical sockets located on and extending away from said first surface, said two open vertical sockets being spaced apart from each other;
heating an injectable material;
injecting said injectable material into at least one injection point located in said mold;
curing said injectable material in said mold to produce said molded ladder safety mat; and
releasing said ladder safety mat from said mold.

11. The method for manufacturing a molded ladder safety mat of claim 10 wherein said providing a mold further comprises:
providing relief surfaces in said cavity for producing a relief pattern on said second side of said ladder safety mat.

12. The method for manufacturing a molded ladder safety mat of claim 10 further comprising:
inserting at least one grommet disposed into said body for accepting a securing device to secure said ladder safety mat to a supporting surface.

13. The method for manufacturing a molded ladder safety mat of claim 10 wherein said non-slip moldable material is selected from the group consisting of rubber, rubber compositions, thermoplastics, fiber reinforced polymers, fiber reinforced plastics, glass strand mat, isophthalic resin, Dycem®, polypropylene, and compositions of these materials.

14. The method for manufacturing a molded ladder safety mat of claim 10 wherein said mold comprises:
a core side and a cavity side that together define a space in which said ladder safety mat can be molded, the core side and cavity side being separable from each other subsequent to the injection to permit removal of said ladder safety mat.

15. The method for manufacturing a molded ladder safety mat of claim 10 wherein said injecting further comprises:
transporting said heated material to said mold through a hot runner system.

16. The method for manufacturing a molded pulley of claim 10 wherein said curing further comprises:
transporting said mold from a heated environment to a curing environment.

17. A ladder safety mat for securing the base of a ladder to a supporting surface comprising:
a flexible body having a first surface and a second surface, said second surface providing a frictional resistance to said supporting surface; and
two vertical U-shaped retaining ends located on said first surface and spaced apart from each other for accepting in each the lower end of a stile from said ladder, wherein said body and said retaining ends are one molded piece.

18. The ladder safety mat of claim 17 further comprising:
at least one grommet disposed through said body for accepting a securing device to secure said ladder safety mat to said supporting surface.

19. The ladder safety mat of claim 17 wherein the openings of said two vertical U-shaped retaining ends face each other.

20. The ladder safety mat of claim 17 wherein the openings of said two vertical U-shaped retaining ends face away from each other.

21. The ladder safety mat of claim 17 wherein said ladder safety mat is made from a non-slip moldable material.

22. The ladder safety mat of claim 21 wherein said non-slip moldable material is selected from the group consisting of rubber, rubber compositions, thermoplastics, fiber reinforced polymers, fiber reinforced plastics, glass strand mat, isophthalic resin, Dycem®, polypropylene, and compositions of these materials.

23. A ladder safety mat for securing the base of a ladder to a supporting surface comprising:
a flexible body having a first surface and a second surface, said second surface providing a frictional resistance to said supporting surface; and
a retaining ridge extending upward from said first surface for providing a lateral resistance to the lower end of a stile from said ladder, wherein said body and said retaining ridge are one molded piece.

24. The ladder safety mat of claim 23 further comprising:
at least one grommet disposed through said body for accepting a securing device to secure said ladder safety mat to said supporting surface.

25. The ladder safety mat of claim 23 wherein the retaining ridge is U-shaped to provide lateral resistance in at least two different directions of said lower ends of said stiles by said retaining ridge.

26. The ladder safety mat of claim 23 wherein said second side further includes a relief pattern.

27. The ladder safety mat of claim 23 wherein said ladder safety mat is made from a non-slip moldable material.

28. The ladder safety mat of claim 27 wherein said non-slip moldable material is selected from the group consisting of rubber, rubber compositions, thermoplastics, fiber reinforced polymers, fiber reinforced plastics, glass strand mat, isophthalic resin, Dycem®, polypropylene, and compositions of these materials.

29. A ladder safety mat for securing the base of a ladder to a supporting surface comprising:
a flexible body having a first surface and a second surface, said second surface providing a frictional resistance to said supporting surface; and
two recessed sockets located in said first surface and spaced apart from each other for accepting in each the lower end of a stile from said ladder, wherein said body and said recessed sockets are one molded piece.

30. The ladder safety mat of claim 29 further comprising:
at least one grommet disposed through said body for accepting a securing device to secure said ladder safety mat to said supporting surface.

31. The ladder safety mat of claim 29 wherein the outer periphery of said recessed sockets are shaped to accept said lower ends of said stiles into said sockets.

32. The ladder safety mat of claim 29 wherein said second side further includes a relief pattern.

33. The ladder safety mat of claim 29 wherein said ladder safety mat is made from a non-slip moldable material.

34. The ladder safety mat of claim 33 wherein said non-slip moldable material is selected from the group consisting of rubber, rubber compositions, thermoplastics, fiber reinforced polymers, fiber reinforced plastics, glass strand mat, isophthalic resin, Dycem®, polypropylene, and compositions of these materials.
